(19) United States
(12) Patent Application Publication
(10) Pub. No.: US 2008/0037265 A1
(43) Pub. Date: Feb. 14, 2008

(54) Lamp

(76) Inventor: Junior Julian Hsu, Northbrook, IL (US)

Correspondence Address: TROXELL LAW OFFICE PLLC, 5205 LEESBURG PIKE, SUITE 1404, FALLS CHURCH, VA, 22041, US

(21) Appl. No.: 11/502,506

(22) Filed: Aug. 11, 2006

(51) Int. Cl. F21V 21/00

(52) U.S. Cl. 362/388; 362/285; 362/414

(57) ABSTRACT

A lamp includes a bottom casing and a top casing. The bottom casing is a hollow pillar with its top opening shrank inwardly to form a bottom inner flange. The interior of the bottom casing is formed with a bottom chamber for disposing the top casing therein. The bottom surface of the bottom casing is connected to a base having an outer supporting ring and an inner supporting ring that partially extend in an outward and oblique manner. Between both supporting rings, an electric line chamber is provided. A battery chamber is further provided beneath the base. The top casing is also a hollow pillar with its bottom opening extending outwardly to form a top outer flange. When the top casing moves upwardly, it cannot be separated from the bottom casing due to the tight engagement between these two casings. The top end of the top casing is connected to a top base. The top base has several supporting pillars and a top plate and is formed with a lamp chamber therebetween. A light-emitting element is positioned in the lamp chamber. The light-emitting element is connected to an electric line. A plurality of intermediate casings is provided between the bottom casing and the top casing.

### BACKGROUND OF THE INVENTION

1. Field of the Invention

The present invention relates to a lamp, and in particular to a lamp having a telescopic structure.

2. Description of Prior Art

Various kinds of lamps having different sizes are already known. Generally, the most common lamp that can be moved according to the necessary conditions is the flashlight. However, such kind of lamp can only emit the light in a straight way and is often gripped by the user's hand. Although it is convenient to use, the intensity of the light emitted by such kind of lamp is so limited that it can be only used in a house or office when an emergent condition such as power failure occurs or be used in traveling outdoors. However, even so, it still has other drawbacks. On the other hand, most desk tables are generally used on a table. Although such kind of lamp is very convenient, it cannot be carried to the outdoors. Therefore, according to the above, the use and the practicability of the conventional lamps still have a blind spot because the conventional structure has a certain degree of influence on the convenience in use. In order to provide an article more conforming to the practical demands, the inventor investigates to solve the above-mentioned problems in prior art.

### SUMMARY OF THE INVENTION

The primary object of the present invention is to provide a telescopic lamp, which offers various heights according to the conditions in use and can be supplied by a DC power or AC power. Further, it can be used as a desk lamp, floor lamp or hanging lamp. Also, since it is provided with a handle, it is portable and the user can take this lamp to go around. Therefore, when going for a picnic or camping, it helps a lot. More particularly, the lamp chamber is designed to have a top cover for restricting the light to only emit the surrounding ground, which is different from the radial emitting of light in prior art. Further, the whole structure is easy to be disposed at any place.

In order to achieve the above objects, the present invention is constructed of a bottom casing and a top casing. The bottom casing is a hollow pillar with its top opening shrank inwardly to form a bottom inner flange. The interior of the bottom casing is formed with a bottom chamber for disposing the top casing therein. The bottom surface of the bottom casing is connected to a base having an outer supporting ring and an inner supporting ring that partially extend in an outward and oblique manner. Between both supporting rings, an electric line chamber is provided. A battery chamber is further provided beneath the base. The top casing is also a hollow pillar with its bottom opening extending outwardly to form a top outer flange. When the top casing moves upwardly, it cannot be separated from the bottom casing due to the tight engagement between these two casings. The top end of the top casing is connected to a top base. The top base has several supporting pillars and a top plate and is formed with a lamp chamber therebetween. A light-emitting element is positioned in the lamp chamber. The light-emitting element is connected to an electric line. A plurality of intermediate casings is provided between the bottom casing and the top casing.

In order to make the Examiner to better understand the technique and measure adopted by the present invention and its resulting effects for achieving the above objects. A preferred embodiment of the present invention will be described in detail with reference to the accompanying drawings. Therefore, the objects, characteristics and advantages of the present invention will be further understood.

### BRIEF DESCRIPTION OF THE DRAWINGS

FIG. 1 is a perspective view of the present invention after retraction;

FIG. 2 is a perspective view of the present invention after extension;

FIG. 3 is a perspective view the present invention in which a quarter thereof is cut off.

### DETAILED DESCRIPTION OF THE INVENTION

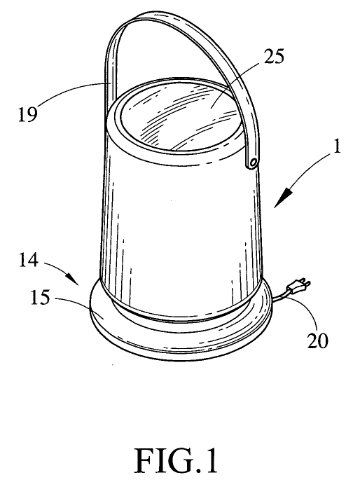

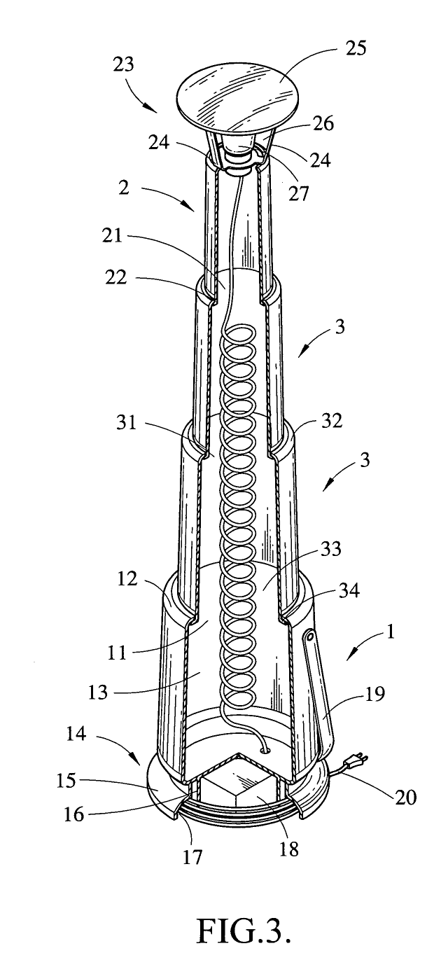

As shown in FIGS. 1 to 3, the present invention is a lamp having a bottom casing 1 and a top casing 2. The top casing 1 is a hollow pillar with its top opening 11 shrank inwardly to form with a bottom inner flange 12. The interior of the bottom casing is further formed with a bottom chamber 13 for disposing the top casing 2 therein. The bottom surface of the bottom casing 1 is connected to a base 14 having an outer supporting ring 15 and an inner supporting ring 16 that partially extend in an outward and oblique manner. Between both supporting rings 15, 16, an electric line chamber 17 is provided. A battery chamber 18 is further provided beneath the base 14. The bottom casing 1 is pivotably provided with a handle 19 near the upper end thereof. With this handle, a user can take the present invention to go around and thus it is very convenient to use at any places.

The top casing 2 is also a hollow pillar with its bottom opening 21 extending outwardly to form a top outer flange 22. When the top casing 2 moves upwardly with respect to the bottom casing 1, since the top outer flange 22 is restricted by the bottom inner flange 12, the top casing 2 cannot be separated from the bottom casing 1 due to the tight engagement between these two casings. The top end of the top casing 2 is connected to a top base 23. The top base 23 has several supporting pillars 24 and a top plate 25 and is formed with a lamp chamber 26 therebetween. A light-emitting element 27 is positioned in the lamp chamber 26. The light-emitting element 27 is connected to an electric line 20. A plurality of intermediate casings 3 is provided between the bottom casing 1 and the top casing 2. At least one intermediate casing 3 can be additionally disposed between the bottom casing 1 and the top casing 2. Each intermediate casing 3 is also a hollow pillar with its top opening 31 shrank inwardly to form a inner flange 32 and with its bottom opening 33 extending outwardly to form an outer flange 34. The intermediate casings 3, the bottom casing 1 and the top casing 2 are all tightly engaged with one another. Each intermediate casing 3 is also tightly engaged with each other (not shown).

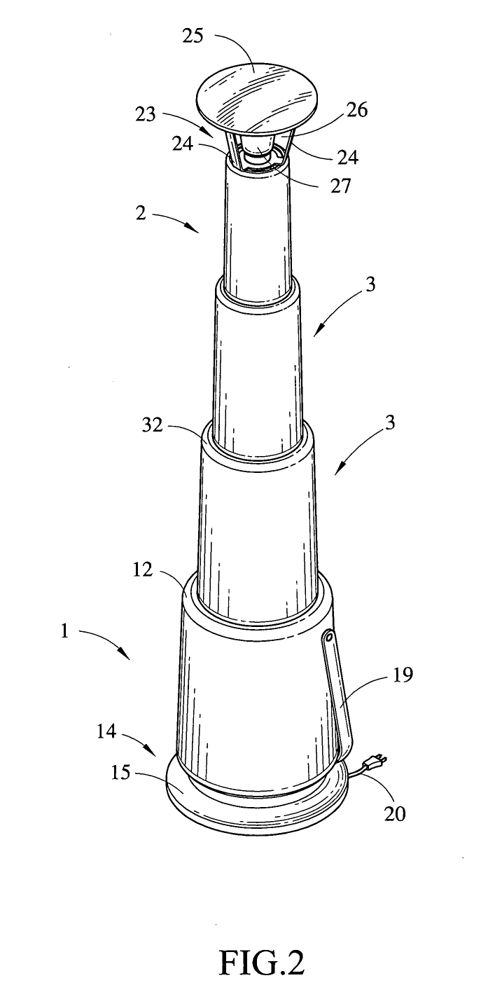

According to the above, the present invention employs a telescopic structure constituted of the bottom casing, the top casing and at least one intermediate casing to form a main body. Such main body can be stably disposed at any proper places, such as a table or floor, so that it can function as a desk lamp or floor lamp. More particularly, the lamp chamber having a top plate can form a covering plate for restricting the projection of the light, thereby to produce the largest and best projecting area. That is to say, with the movement of the top casing, the projecting area can be enlarged, which is a special effect much different from that of the conventional lamps. With such arrangement, the lamp is easy to extend or retract and convenient to carry about. When the lamp retracts, it is under a state as shown in FIG. 1. On the other hand, in use, the lamp extends to be under a state as shown in FIG. 2. Further, the use can take the lamp to go around and thus it can be applied in a wide range. Moreover, since the lamp can be supplied with DC power or AC power, it can be used indoors or outdoors and very helpful to all people especially when go for a picnic in the night. Therefore, the present invention offers an excellent usability and is a novel design totally different from that of prior art.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A lamp, comprising:
a bottom casing being a hollow pillar with its top opening shrank inwardly to form a bottom inner flange, a bottom chamber formed within the interior of the bottom casing for disposing a top casing therein, the bottom surface of the bottom casing connected to a base having an outer supporting ring and an inner supporting ring partially extending in an outward and oblique manner, an electric line chamber provided between the two supporting rings, a battery chamber further provided under the base; and
a top casing also being a hollow pillar with its bottom opening extending outwardly to form a top outer flange, wherein
the top casing cannot be separated from the bottom casing when the top casing moves upwardly, a tight engagement is produced between the bottom casing and the top casing, the top end of the top casing is connected to a top base having several supporting pillars and a top plate, a lamp chamber is formed between the supporting pillars and the top plate, a light-emitting element is positioned in the lamp chamber, and the light-emitting element is connected to an electric line.

2. The lamp according to claim 1, wherein at least one intermediate casing is provided between the bottom casing and the top casing, each intermediate casing is also a hollow pillar with its top opening shrank inwardly to form an inner flange and with its bottom opening extending outwardly to form an outer flange, so that the intermediate casing, bottom casing and the top casing are tightly engaged with one another.

3. The lamp according to claim 1, wherein the bottom casing is pivotably provided with a handle near its upper end.
